(19) United States
(12) Patent Application Publication
(10) Pub. No.: US 2023/0219558 A1
(43) Pub. Date: Jul. 13, 2023

(54) DRIVING FORCE CONTROL SYSTEM FOR VEHICLE

(71) Applicant: TOYOTA JIDOSHA KABUSHIKI KAISHA, Toyota-shi (JP)

(72) Inventors: Yu INASE, Susono-shi (JP); Akira IJICHI, Odawara-shi (JP); Yoshio ITOU, Susono-shi (JP); Taichi KOBAYASHI, Susono-shi (JP); Kunihiko USUI, Fuji-shi (JP)

(73) Assignee: TOYOTA JIDOSHA KABUSHIKI KAISHA, Toyota-shi (JP)

(21) Appl. No.: 18/051,995

(22) Filed: Nov. 2, 2022

(30) Foreign Application Priority Data
Nov. 30, 2021 (JP) 2021-194819

(51) Int. Cl. B60W 20/16; B60W 10/08; B60W 10/06

(52) U.S. Cl. CPC B60W 20/16; B60W 10/06; B60W 10/08; B60W 2510/0208; B60W 2510/244; B60W 2520/263; B60W 2552/15; B60W 2710/083

(57) ABSTRACT

A driving force control system for a vehicle that eliminates backlash in torque transmission paths when decelerating or stopping the vehicle. In the vehicle, a differential unit reverses a torque delivered from a motor to a second output shaft. A controller generates a drive torque by an engine and a control torque by the motor when stopping or decelerating the vehicle. Consequently, a difference between torque delivered from the engine to a first output shaft and torque delivered from the motor to the first output shaft is increased to a first predetermined torque or greater, and torque delivered from the motor to the second output shaft is increased to a second predetermined torque or greater.

### CROSS REFERENCE TO RELATED APPLICATIONS

The present disclosure claims the benefit of Japanese Patent Application No. 2021-194819 filed on Nov. 30, 2021 with the Japanese Patent Office, the entire contents of which are incorporated herein by reference in its entirety.

### BACKGROUND

### Field of the Disclosure

Embodiments of the present disclosure relate to the art of a control system for controlling a driving force of a vehicle having a differential mechanism that distributes a torque generated by a prime mover to front wheels and rear wheels.

### Discussion of the Related Art

JP-A-2007-246056 describes a drive controller of all-wheel drive vehicle having a first differential mechanism, a differential limiting clutch, and a second differential mechanism. The first differential mechanism comprises an input element connected to a prime mover, a first output element connected to front wheels, and a second output element connected to rear wheels. In the first differential mechanism, the first output element and the second output elements are selectively connected to each other through the differential limiting clutch. In the second differential mechanism, the first output element, the second output element, and a motor are connected to one another in a differential manner. Specifically, in the second differential mechanism, torque applied to the first output element is reversed to an opposite direction to a direction of torque applied to the second output element by generating torque by the motor. In the vehicle described in JP-A-2007-246056, an output torque of the prime mover is distributed to the front wheels and the rear wheels in accordance with a gear ratio (i.e., a torque split ratio) of the first differential mechanism. That is, when driving the prime mover, the torque distribution ratio to the front wheels and the rear wheels can be controlled by controlling the torque of the motor. By contrast, when the prime mover is stopped, the output torque of the motor is delivered to the front wheels and the rear wheels to propel the vehicle by engaging the differential limiting clutch. Thus, in the vehicle described in JP-A-2007-246056, the motor changes the torque distribution ratio to the front wheels and the rear wheels, and serves as a prime mover in an electric vehicle mode.

JP-A-2021-131153 describes a power transmission device for a vehicle. In the vehicle described in JP-A-2021-131153, a first output shaft to which torque of an engine is delivered is connected to rear wheels, and a second output shaft is connected to front wheels. The first output shaft, the second output shaft, and a motor are connected to one another in a differential manner through a differential mechanism so that torque applied to the first output element is reversed to an opposite direction to a direction of torque applied to the second output element by generating torque by the motor. The vehicle described in JP-A-2021-131153 is propelled in a four-wheel drive mode in which the torque of the engine is distributed to the front wheels and the rear wheels by generating torque by the motor, and in a two-wheel drive mode in which the torque of the engine is delivered only to the rear wheels by stopping torque generation of the motor.

JP-A-2003-65106 describes a power output device configured to reduce backlash in a transmission during braking of an electric vehicle in which an engine, drive wheels, and a motor are connected to one another through a differential mechanism. Specifically, the power output device described in JP-A-2003-65106 is configured to control torque of the motor in such a manner that creep torque greater than a lower limit guard value is applied to the drive wheels until a predetermined period of time has elapsed from a point at which the vehicle being decelerated was stopped.

JP-A-2020-185930 describes a control device of hybrid vehicle having an engine, drive wheels and first motor connected to one another in a differential manner through a differential mechanism, and a second motor disposed between the differential mechanism and the drive wheels. The control device described in JP-A-2020-185930 is configured to eliminate backlash in the differential mechanism during propulsion in an electric vehicle mode in which the vehicle is propelled only by torque of the second motor while stopping the engine. Specifically, when cogging torque established according to an electric angle of the first motor during propulsion in the electric vehicle mode is greater than torque required to eliminate the backlash, the control device described in JP-A-2020-185930 reduces electric consumption to eliminate the backlash when the vehicle is stopped by reducing an electric power supplied to the first motor compared to a case in which the electric angle of the first motor is different.

As described, the vehicle described in JP-A-2007-246056 has the first differential mechanism that distributes the output torque of the engine to the front wheels and the rear wheels, and the second differential mechanism that distributes the output torque of the motor to the front wheels and the rear wheels. Therefore, a structure to change the torque distribution ratio to the front wheels and the rear wheels has to be enlarged, and an axial length of a power transmission unit has to be elongated.

In order to downsize the power transmission unit, in the vehicle described in JP-A-2021-131153, the first output shaft that delivers the torque from the engine to the rear wheels the second output shaft that delivers the torque to the front wheels, and the motor are connected to one another in a differential manner. In the vehicle of this kind, the torque distribution ratio to the front wheels and the rear wheels may be controlled arbitrarily by one differential mechanism.

However, in the vehicle described in JP-A-2021-131153, the torque is delivered to the front wheels by driving the motor. Therefore, if the motor is stopped when decelerating or stopping the vehicle by applying braking forces to all of the wheels, the creep torque of the engine is applied only to the rear wheels. Consequently, backlash among gears in the differential mechanism as well as in a torque transmission path between the differential mechanism and the front wheels may not be eliminated. In this situation, if the vehicle is launched or accelerated, noises and vibrations would be generated due to sudden elimination of the backlash. In addition, if the motor generates torque to eliminate the backlash in this situation, the torque of the motor counteracts the torque of the engine delivered to the rear wheels. Consequently, the backlash among gears in the torque transmission path between the differential mechanism and the rear wheels may not be eliminated. In this case, noises and vibrations would also be generated due to sudden elimination of the backlash when the vehicle is launched or accelerated.

### SUMMARY

Aspects of the present disclosure have been conceived noting the foregoing technical problems, and it is therefore an object of the present disclosure to provide a driving force control system for a vehicle that eliminates backlash in torque transmission paths between a differential mechanism and front wheels and between the differential mechanism and rear wheels when decelerating or stopping the vehicle.

An exemplary embodiment of the present disclosure relates to a driving force control system for a vehicle, comprising: a prime mover; a first output shaft that delivers torque generated by the prime mover to any one of pairs of front and rear wheels; a second output shaft that is connected to other one of the pairs of the front wheels and the rear wheels; and a differential unit that connects the first output shaft, the second output shaft, and a motor in a differential manner, and that reverses a torque delivered from the motor to the second output shaft to a direction opposite to a direction of a torque delivered from the motor to the first output shaft. In order to achieve the above-explained objective, according to the exemplary embodiment of the present disclosure, the driving force control system is provided with a controller that controls the prime mover and the motor. Specifically, the controller is configured to generate a predetermined drive torque by the prime mover and a control torque falling within a predetermined range by the motor when stopping or decelerating the vehicle, such that a difference between the torque delivered from the prime mover to the first output shaft and the torque delivered from the motor to the first output shaft is increased to or greater than a first predetermined torque, and that the torque delivered from the motor to the second output shaft is increased to or greater than a second predetermined torque.

In a non-limiting embodiment, the controller may be further configured to adjust the control torque generated by the motor based on a predetermined condition including a running condition and an operating mode of the vehicle.

In a non-limiting embodiment, the controller may be further configured to generate the control torque by the motor based on a predetermined condition including a running condition and an operating mode of the vehicle.

In a non-limiting embodiment, the predetermined condition may include whether the operating mode is in a fuel saving mode.

In a non-limiting embodiment, the predetermined condition may include whether it is required to propel the vehicle in a mode in which the torque is distributed to both pairs of the front wheels and the rear wheels.

In a non-limiting embodiment, the vehicle may further comprise a clutch that selectively connects at least any two of the first output shaft, the second output shaft, and the motor. In addition, the predetermined condition may include an engagement state of the clutch.

In a non-limiting embodiment, the predetermined condition may include a road grade.

In a non-limiting embodiment, the predetermined condition may include a slip ratio of at least one of the pairs of the front wheels and the rear wheels.

In a non-limiting embodiment, the vehicle may further comprise an electric storage device that supplies an electric power to the motor. In addition, the controller is further configured to generates the control torque by the motor when a state of charge level of the electric storage device is a predetermined level or higher.

As described, the control system according to the exemplary embodiment of the present disclosure is applied to a vehicle comprising: the first output shaft that delivers torque generated by the prime mover to any one of pairs of front and rear wheels; the second output shaft that is connected to other one of the pairs of the front wheels and the rear wheels; and the differential unit that connects the first output shaft, the second output shaft, and a motor in a differential manner. In the vehicle, the torque delivered from the motor to the second output shaft is reversed to a direction opposite to a direction of the torque delivered from the motor to the first output shaft. When stopping or decelerating the vehicle, the controller generates a predetermined drive torque by the prime mover and a control torque falling within a predetermined range by the motor, such that the difference between the torque delivered from the prime mover to the first output shaft and the torque delivered from the motor to the first output shaft is increased to or greater than the first predetermined torque, and that the torque delivered from the motor to the second output shaft is increased to or greater than the second predetermined torque. According to the exemplary embodiment of the present disclosure, therefore, torques are delivered to torque transmission paths between the differential unit and the front wheels and between the differential unit and the rear wheels in a direction to propel the vehicle. Consequently, backlash existing in gear pairs arranged in the torque transmission paths has already been reduced to the drive side when launching or accelerating the vehicle. For this reason, the noises and the shocks (i.e., vibrations) are reduced when launching the vehicle being stopped and when accelerating the vehicle being decelerated. In addition, the acceleration response to a launching operation and an accelerating operation is improved.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the vehicle to which the control system according to the exemplary embodiment of the present disclosure is applied;

FIG. 2 is a nomographic diagram showing torques acting in a center differential unit during forward travel;

FIG. 3 is a nomographic diagram showing torques acting in the center differential unit during reverse travel;

FIG. 4 is a flow chart showing one example of a routine executed by the control system according to the exemplary embodiment of the present disclosure;

FIG. 5 is a flow chart showing an example of the routine to change a control torque based on a selection of an energy saving mode;

FIG. 6 is a flow chart showing an example of the routine to change the control torque based on demand to propel the vehicle in a four-wheel drive mode;

FIG. 7 is a flow chart showing an example of the routine to change the control torque based on an engagement state of a clutch; and

FIG. 8 is a flow chart showing an example of the routine to change the control torque based on a road grade and a slip ratio of the wheels.

### DETAILED DESCRIPTION

Embodiments of the present disclosure will now be explained with reference to the accompanying drawings. Note that the embodiments shown below are merely examples of the present disclosure, and do not limit the present disclosure.

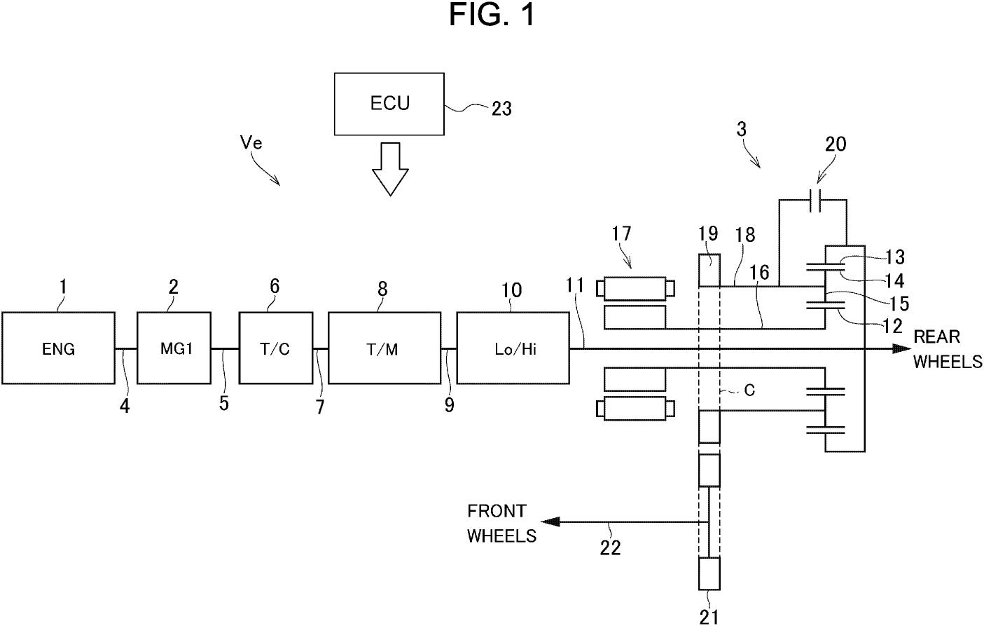

Referring now to FIG. 1, there is shown an example of a structure of a vehicle Ve to which the driving force control system according to the exemplary embodiment of the present disclosure is applied. The vehicle Ve shown in FIG. 1 is a hybrid vehicle in which a prime mover includes an engine (referred to as “ENG” in FIG. 1) 1 and a first motor (referred to as “MG1” in FIG. 1) 2. In the vehicle Ve, torques generated by the engine 1 and the first motor 2 are delivered not only to a pair of rear wheels but also to a pair of front wheels through a center differential unit 3.

For example, a gasoline engine and a diesel engine may be adopted as the engine 1, and the engine 1 generates torque by burning air/fuel mixture.

In the vehicle Ve, the engine 1 is mounted longitudinally such that an output shaft 4 extends in the longitudinal direction of the vehicle Ve, and the output shaft 4 of the engine 1 is joined to the first motor 2. For example, a permanent magnet synchronous motor and an induction motor may be adopted as the first motor 2. That is, the first motor 2 serves not only as a motor that generates drive torque to increase a rotational speed of the output shaft 4 of the engine 1, but also as a generator that generates regenerative torque to reduce a rotational speed of the output shaft 4 thereby translating a kinetic energy of the output shaft 4 into electric power.

An output shaft 5 of the first motor 2 is joined to a torque converter (referred to as “T/C” in FIG. 1) 6. As an option, a lockup clutch may be arranged to selectively connect the output shaft 5 of the first motor 2 to an output shaft 7 of the torque converter 6 thereby rotating those shafts integrally.

The output shaft 7 of the torque converter 6 is joined to a transmission (referred to as “T/M” in FIG. 1) 8. For example, a geared transmission that shifts a gear stage among a plurality of stages, and a continuously variable transmission that varies a speed ratio by changing an effective running diameter of a belt may be adopted as the transmission 8. Given that the geared transmission is employed as the transmission 8, a reverse stage in which the torque is reversed to people the vehicle Ve in the reverse direction is available. Whereas, given that the continuously variable transmission is employed as the transmission 8, a torque reversing device is arranged in an input side or an output side of the transmission 8 to selectively reverse a direction of the torque.

An output shaft 9 of the transmission 8 is joined to a sub-transmission (referred to as “Lo/Hi” in FIG. 1) 10. The sub-transmission 10 switches the gear stage between a fixed stage (or speed increasing stage) and a speed reducing stage in response to an operation of a switch (not shown) between a High position and a Low position. Specifically, the gear stage is switched to the fixed stage by moving the switch to the High position, and to the speed reducing stage by moving the switch to the Low position.

An output shaft 11 of the sub-transmission 10 as a first output shaft is connected to the pair of rear wheels through a rear propeller shaft, a rear differential gear unit, and rear driveshafts (neither of which are shown).

In order to deliver the torque of the prime mover to the pair of front wheels, the center differential unit 3 are arranged around the output shaft 11 of the sub-transmission 10. According to the exemplary embodiment of the present disclosure, a single-pinion planetary gear unit is adopted as the center differential unit 3. Specifically, the center differential unit 3 comprises: a sun gear 12 that is formed around the output shaft 11 to be rotated relatively to the output shaft 11; a ring gear 13 that is arranged concentrically around the sun gear 12 and joined to the output shaft 11; a plurality of pinion gears 14 interposed between the sun gear 12 and the ring gear 13 while meshing with those gears; and a carrier 15 that supports the pinion gears 14 in a rotatable manner such that the pinion gears 14 revolves around the output shaft 11. Instead, other kinds of differential mechanism e.g., a double-pinion planetary gear unit may also be adopted as the center differential unit 3.

The sun gear 12 is joined to a first cylindrical shaft 16 extending toward the sub-transmission 10, and a leading end of the first cylindrical shaft 16 is joined to a second motor 17 serving as a motor of the exemplary embodiment of the present disclosure. That is, the output shaft 11 penetrates through the first cylindrical shaft 16 and the second motor 17. The second motor 17 is adapted to alter a torque distribution ratio of the center differential unit 3, and for example, a direct current motor and an alternating current motor may be adopted as the second motor 17.

The carrier 15 is joined to a second cylindrical shaft 18 extending toward the second motor 17, and a leading end of the second cylindrical shaft 18 is joined to a drive sprocket 19. That is, the first cylindrical shaft 16 penetrates through the second cylindrical shaft 18 and the drive sprocket 19.

In order to restrict a differential action of the center differential unit 3, a clutch 20 is arranged to selectively connect the second cylindrical shaft 18 (i.e., the carrier 15) to the ring gear 13. For example, a friction clutch and a dog clutch may be adopted as the clutch 20. Instead, the clutch 20 may also be adapted to selectively connect the sun gear 12 to the carrier 15 or the ring gear 13. Thus, the clutch 20 is adapted to selectively connect any two of the rotary elements of the center differential unit 3 as a single-pinion planetary gear unit.

As illustrated in FIG. 1, a front propeller shaft 22 as a second output shaft extends parallel to the output shaft 11, and a driven sprocket 21 is joined to the leading end of the front propeller shaft 22. A chain C is applied to the drive sprocket 19 and the driven sprocket 21 so that power of the drive sprocket 19 is transmitted to the driven sprocket 21. The front propeller shaft 22 is connected to the pair of front wheels through a front differential gear unit and front driveshafts (neither of which are shown) so that torque of the driven sprocket 21 is delivered to the front wheels via the front propeller shaft 22. In order to control the engine 1, the first motor 2, and the second motor 17, the vehicle Ve is provided with an electronic control unit (to be abbreviated as “ECU” hereinafter) 23 as a controller comprising a microcomputer. The ECU 23 is electrically connected with various sensors (not shown) so that data collected by the sensors is sent to the ECU 23 in the form of signal. For example, the ECU 23 determines speeds and torques of the engine 1, the first motor 2, and the second motor 17 based on the incident data transmitted from the sensors as well as maps and formulas installed in advance, and transmits determined target values of the speeds and torques to the engine 1, the first motor 2, and the second motor 17 in the form of command signal. According to the exemplary embodiment of the present disclosure, the sensors include: an engine speed sensor that detects a speed of the engine 1; motor speed sensors that detect speeds of the motors 2 and 17; a vehicle speed sensor that detects a speed of the vehicle Ve; a shift position sensor that detects a position of a shift lever (not shown); a battery sensor that detects a state of charge (hereinafter abbreviated as “SOC”) level of an electric storage device connected with the motors 2 and 17; temperature sensors that detect temperatures of the motors 2 and 17; an accelerator sensor that detects a depression of an accelerator pedal (not shown); a brake sensor that detects a depression of a brake pedal (not shown) and a pedal force applied to the brake pedal; a switch sensor that detects a position of a mode selector switch (not shown); another switch sensor that detects a position of a multi-terrain selector switch for selecting a control mode of driving force depending on a road surface condition; and a road grade sensor that detects a grade of a road on which the vehicle Ve travels.

In the center differential unit 3, the carrier 15 and the ring gear 13 are rotated relatively to each other when the front wheels and the rear wheels are rotated at different speeds. In this situation, the second motor 17 is rotated to absorb a speed difference between the carrier 15 and the ring gear 13. When the engine 1 and the first motor 2 are generating torques, the torques generated by the engine 1 and the first motor 2 may be delivered partially to the front wheels in accordance with a magnitude of torque generated by the second motor 17. In this situation, the torques delivered from the engine 1 and the first motor 2 to the rear wheels are reduced. That is, a torque distribution ratio to the front wheels and the rear wheels is changed by controlling the torque generated by the second motor 17. In other words, torque transmission between the front wheels and the engine 1 or the first motor 2 is interrupted by not generating the torque by the second motor 17. Thus, the center differential unit 3 is a part-time differential unit that allows the vehicle Ve to selectively propel in a two-wheel drive mode in which drive torque is delivered only to the rear wheels, and in a four-wheel drive mode in which drive torque is delivered to both of the front wheels and the rear wheels.

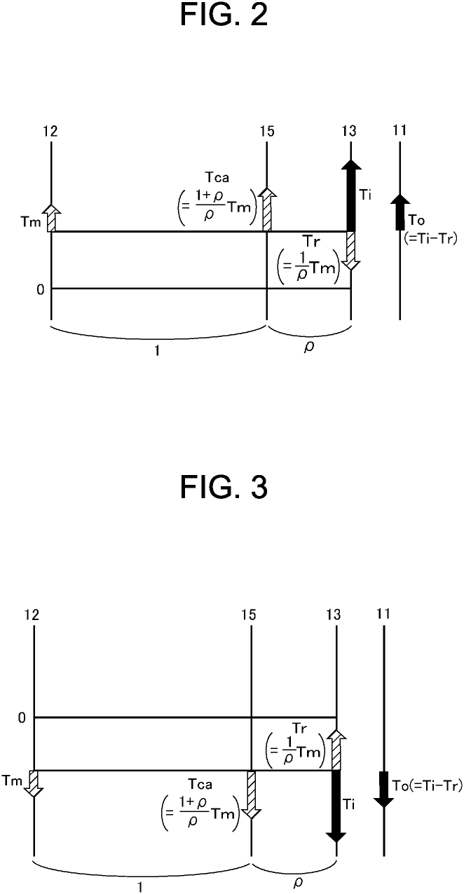

FIG. 2 shows conditions of the rotary elements of the center differential unit 3 in a situation in which the vehicle Ve is propelled in the forward direction by generating torque by at least one of the engine 1 and the first motor 2 while generating torque by the second motor 17. On the other hand, FIG. 3 shows conditions of the rotary elements of the center differential unit 3 in a situation in which the vehicle Ve is reversed by generating torque by at least one of the engine 1 and the first motor 2 while generating torque by the second motor 17. In the following explanations, the torque delivered to the center differential unit 3 from the engine 1 and the first motor 2 will be simply referred to as the input torque Ti.

As indicated by the black arrows in FIGS. 2 and 3, a rotational speed of the ring gear 13 is increased by the input torque Ti. Whereas, a rotational speed of the sun gear 12 is increased by the torque of the second motor 17 (hereinafter referred to as the motor torque) Tm. In the situation in which the motor torque Tm is delivered to the sun gear 12, torque Tca is applied to the carrier 15 and torque Tr is applied to the ring gear 13 in accordance with a magnitude of the motor torque Tm, and a gear ratio p(Zs/Zr) between the number of teeth Zs of the sun gear 12 and the number of teeth Zr of the ring gear 13. Specifically, the torque Tca is expressed as “Tca=((1+ρ]/ρ]Tm”, and applied to the carrier 15 in a direction to increase a speed of the carrier 15. On the other hand, the torque Tr is expressed as “Tr=(⅟p)Tm”, and applied to the ring gear 13 in a direction to reduce a speed of the ring gear 13. That is, the torque Tca applied to the carrier 15 is delivered to the front wheels to drive the front wheels, and the torque Tr applied to the ring gear 13 is delivered to the rear wheels to reduce the drive torque rotating the rear wheels. In other words, the torque Tr applied to the ring gear 13 counteracts the input torque Ti to the center differential unit 3. Specifically, the input torque Ti is reduced by the torque Tr applied to the ring gear 13, and output torque To thus reduced by the torque Tr is delivered from the center differential unit 3 to the rear wheel. Accordingly, given that the torque Tr applied to the ring gear 13 by generating the motor torque Tm by the second motor 17 is greater than the input torque Ti to the center differential unit 3, the direction of the torque delivered to the rear wheels is reversed.

As described, in the case that the second motor 17 does not generate the motor torque Tm, the torque will not be applied to the gears in the torque transmission path between the center differential unit 3 and the front wheels. When the vehicle Ve is stopped or decelerated by the brakes arranged in the wheels, therefore, backlash would be created between gears arranged between the center differential unit 3 and the front wheels. By contrast, in a case that the torque delivered from the second motor 17 to the ring gear 13 is greater than the input torque Ti equivalent to creep torque, the torque is applied to the gears arranged between the center differential unit 3 and the rear wheels in the direction opposite to the drive torque to propel the vehicle Ve. In this case, therefore, backlash would be created between gears arranged between the center differential unit 3 and the rear wheels when the vehicle Ve is stopped or decelerated by the brakes arranged in the wheels. It is to be noted that the drive torque equivalent to the creep torque is generated by at least one of the engine 1 and the first motor 2 when the vehicle Ve is stopped or decelerated.

Therefore, if the vehicle Ve is launched or accelerated in the situation in which backlash exists in gear pairs arranged between the center differential unit 3 and the front wheels or the rear wheels, noises and shocks will be generated due to sudden elimination of the backlash. In addition, a response to an accelerating operation or a launching operation would be reduced.

In order to avoid the above-explained disadvantages, the control system according to the exemplary embodiment of the present disclosure is configured to control the motor torque Tm in such a manner as to reduce the noises and the shocks and to improve the acceleration response when launching the vehicle Ve being stopped and when accelerating the vehicle Ve being decelerated. For these purposes, specifically, the control system according to the exemplary embodiment of the present disclosure controls the motor torque Tm in such a manner as to apply drive torques to the wheels in a travelling direction of the vehicle Ve.

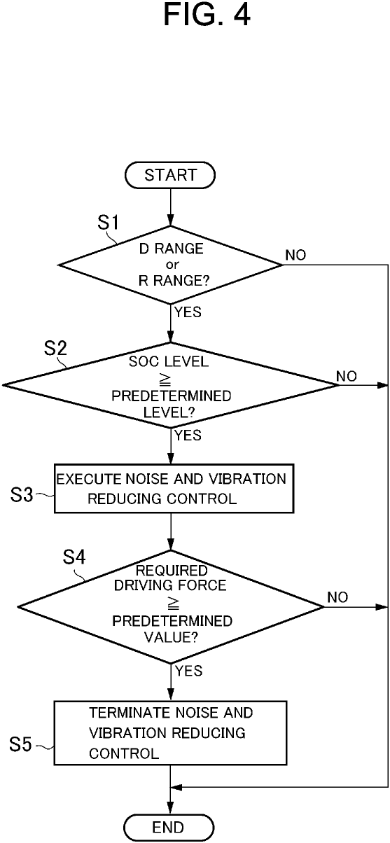

For these purposes, for example, the control system according to the exemplary embodiment of the present disclosure executes a routine shown in FIG. 4 when the vehicle Ve is stopped or decelerated. In order to determine whether to generate the motor torque Tm to launch or accelerate the vehicle Ve, at step S1, it is determined whether a forward drive range (D range) or a reverse range (R range) is selected. Such determination at step S1 may be made based on a signal transmitted from a sensor detecting a position of a range selector lever.

If neither the forward drive range nor the reverse range is selected so that the answer of step S1 is NO, the routine returns. In this case, if an after-mentioned noise and vibration reducing control has already been executed in the previous routine, the noise and vibration reducing control is terminated. By contrast, if the forward drive range or the reverse range is selected so that the answer of step S1 is YES, the routine progresses to step S2 to determine whether an SOC level of the electric storage device is a predetermined level or higher. That is, at step S2, it is determined whether the second motor 17 is allowed to generate the torque Tm to reduce the backlash existing in the gear pairs arranged between the center differential unit 3 and the front wheels. Specifically, at step S2, it is determined whether the second motor 17 is allowed to generate an after-mentioned control torque Tc required during execution of the noise and vibration reducing control. Here, it is to be noted that the predetermined level of the SOC level may be altered depending on a speed and a temperature of the second motor 17.

If the SOC level of the electric storage device is lower than the predetermined level so that the answer of step S2 is NO, the routine returns. In this case, if the noise and vibration reducing control has been executed in the previous routine, the noise and vibration reducing control is also terminated. In this situation, it is preferable to generate torques by the engine 1 and the first motor 2 to eliminate the backlash existing in the gear pairs arranged between the center differential unit 3 and the rear wheels. By contrast, if the SOC level of the electric storage device is the predetermined level or higher so that the answer of step S2 is YES, the routine progresses to step S3 to execute the noise and vibration reducing control thereby controlling the motor torque Tm in such a manner as to eliminate the backlash existing in the gear pairs arranged between the center differential unit 3 and the front wheels, and between the center differential unit 3 and the rear wheels. Specifically, the motor torque Tm is adjusted such that a difference between the input torque Ti and the torque Tr applied to the ring gear 13 is increased to or greater than a first predetermined torque T1 that is required to eliminate the backlash existing in the gear pairs arranged between the center differential unit 3 and the rear wheels, and that the torque applied to the carrier 15 is increased to or greater than a second predetermined torque T2 that is required to eliminate the backlash existing in the gear pairs arranged between the center differential unit 3 and the front wheels. More specifically, the motor torque Tm is adjusted in such a manner as to satisfy both of the following inequality expressions:

$$\text{Ti-} \left(1 / \text{ρ}\right) \text{Tm} ≧ \text{T1}$$

and

$$\left(\left(1 + \text{ρ}\right) / \left(\text{ρ}\right) \text{Tm} ≧ \text{T} 2\right)$$

That is, the motor torque Tm is adjusted to fall within a predetermined range expressed by the following inequality expression:

$$\text{T} 2 \left(\text{ρ} / \left(1 + \text{ρ}\right)\right) ≦ \text{Tm} ≦ \left(\text{Ti-T1}\right) \text{ρ}$$

In the following explanations, the torque which satisfies both of the above inequalities (1) and (2) will be referred to as the control torque Tc.

Then, it is determined at step S4 whether a required driving force is a predetermined value or greater. That is, it is determined at step S4 whether to terminate the noise and vibration reducing control. To this end, the predetermined value of the driving force is set to or greater than a driving force of the case in which the creep torque is applied to the front wheels and the rear wheels.

If the required driving force is less than the predetermined value so that the answer of step S4 is NO, the routine returns. In this case, specifically, the second motor 17 continues to generate the control torque Tc. By contrast, if the required driving force is the predetermined value or greater so that the answer of step S4 is YES, the routine progresses to step S5 to terminate the noise and vibration reducing control. In this case, specifically, the engine 1, the first motor 2, and the second motor 17 are controlled to generate driving forces to generate the required driving force.

Thus, when the vehicle Ve is stopped or decelerated, the torque of the second motor 17 is controlled in such a manner as to eliminate the backlash existing in the gear pairs arranged between the center differential unit 3 and the front wheels, and between the center differential unit 3 and the rear wheels. According to the exemplary embodiment of the present disclosure, therefore, the backlash existing in the gear pairs has already been reduced to the drive side when launching or accelerating the vehicle Ve. For this reason, the noises and the shocks (i.e., vibrations) are reduced when launching the vehicle Ve being stopped and when accelerating the vehicle Ve being decelerated. In addition, the acceleration response to the launching operation and the accelerating operation is improved.

During execution of the noise and vibration reducing control, the second motor 17 is energized to generate the torque. Consequently, electric power will be consumed and wasted due to copper loss and iron loss. Since the electric storage device is charged to energize the second motor 17 by operating the engine 1, a total fuel consumption of the vehicle Ve would be increased to execute the noise and vibration reducing control.

In addition, there is a certain range of the control torque Tc to satisfy both of the above-mentioned inequalities (1) and (2) so as to eliminate the backlash existing in the gear pairs.

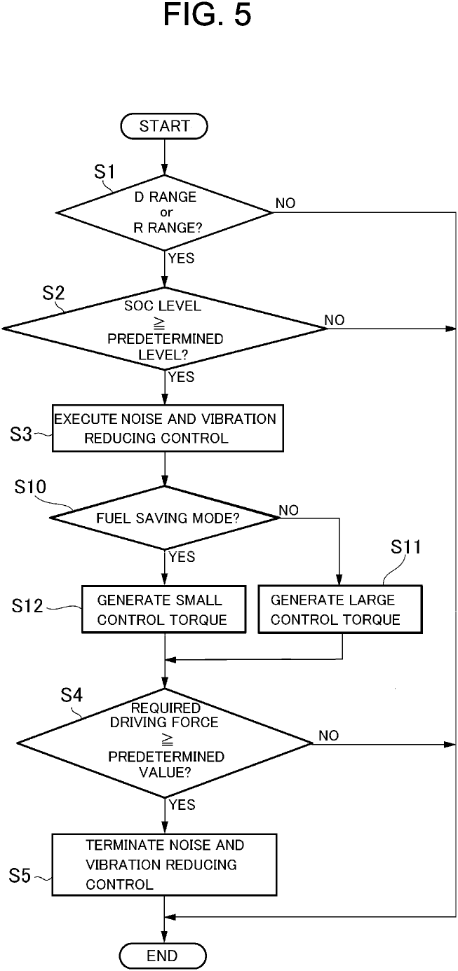

According to the exemplary embodiment of the present disclosure, therefore, the control torque Tc may be changed depending on a running condition or an operating mode of the vehicle Ve, or an execution of the noise and vibration reducing control may be permitted depending on a running condition or an operating mode of the vehicle Ve. To this end, the control system according to the exemplary embodiment of the present disclosure is further configured to execute a routine shown in FIG. 5. In the following description, detailed explanations for the steps in common with those of the routine shown in FIG. 4 will be omitted.

In the routine shown in FIG. 5, the routine progresses from step S3 to step S10 to determine whether a fuel saving mode is selected. The fuel saving mode includes an economy mode in which fuel is saved with priority over a driving performance such as the acceleration response. For example, if a sports mode in which agility of the vehicle Ve is enhanced is selected so that the answer of step S10 is NO, the routine progresses to step S11 to generate the relatively large control torque Tc by the second motor 17 within the range possible to satisfy both of the above-mentioned inequalities (1) and (2). Thereafter, the routine progresses to step S4. By contrast, if the fuel saving mode is selected so that the answer of step S10 is YES, the routine progresses to step S12 to generate the relatively small control torque Tc by the second motor 17 within the range possible to satisfy both of the above-mentioned inequalities (1) and (2). Thereafter, the routine also progresses to step S4.

Instead, in the case that the fuel saving mode is selected so that the answer of step S10 is YES, the noise and vibration reducing control may be terminated. In this case, the routine progresses directly from step S10 to step S5. Otherwise, the determination at step S10 may also be made prior to step S3. In this case, if the fuel saving mode is selected so that the answer of step S10 is YES, an execution of the noise and vibration reducing control may be inhibited. In other words, in the case that the answer of step S10 is YES, the torque generation by the second motor 17 may be inhibited. Instead, in order to reduce the noises and shocks to a certain extent when launching or accelerating the vehicle Ve, it is also possible to generate torque smaller than the control torque Tc by the second motor 17. Thus, during propulsion in the fuel saving mode, the torque of the second motor 17 may be reduced.

By thus reducing the control torque Tc or the output torque of the second motor 17 during propulsion in the energy saving mode, the fuel efficiency of the vehicle Ve may be further improved.

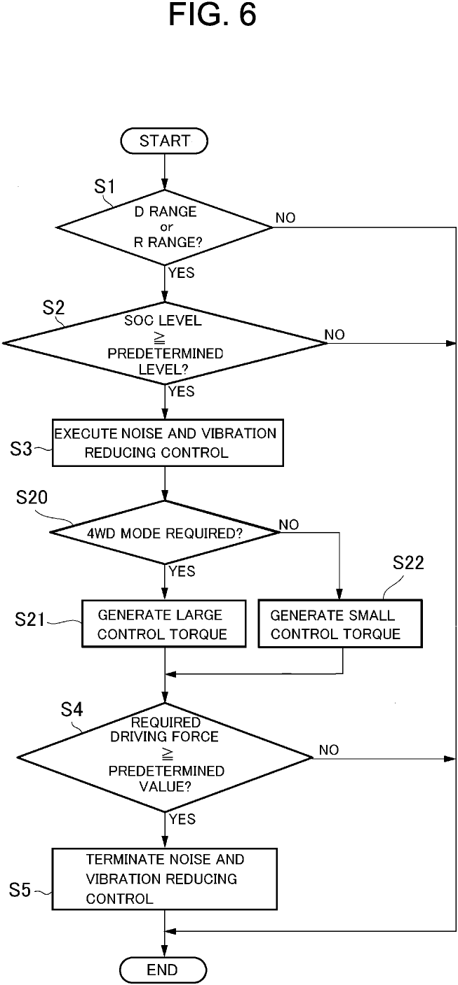

According to the exemplary embodiment of the present disclosure, the control system is further configured to adjust the control torque Tc depending on whether or not the four-wheel drive mode is selected. To this end, the control system according to the exemplary embodiment of the present disclosure executes a routine shown in FIG. 6. In the following description, detailed explanations for the steps in common with those of the foregoing routines will be omitted.

In the routine shown in FIG. 6, the routine progresses from step S3 to step S20 to determine whether it is required to propel the vehicle Ve in the four-wheel drive mode. Such determination at step S20 may be made based on an operation of a switch. Specifically, such determination at step S20 may be made based on a signal transmitted from the mode selector switch or the muti-terrain selector switch. In order to propel the vehicle Ve in the four-wheel drive mode, it is necessary to generate the driving force promptly when launching or accelerating the vehicle Ve. For this purpose, it is preferable to eliminate the backlash existing in the gear pairs certainly when decelerating or stopping the vehicle Ve, and to apply relatively large torques to the front wheels and the rear wheels when those wheels are released from the braking forces.

Therefore, if it is required to propel the vehicle Ve in the four-wheel drive mode so that the answer of step S20 is YES, the routine progresses to step S21 to generate the relatively large control torque Tc by the second motor 17 within the range possible to satisfy both of the above-mentioned inequalities (1) and (2). Thereafter, the routine progresses to step S4. By contrast, if it is not required to propel the vehicle Ve in the four-wheel drive mode so that the answer of step S20 is NO, in other words, if the vehicle Ve is allowed to propel not only in the two-wheel drive mode but also in the four-wheel drive mode so that the answer of step S20 is NO, the routine progresses to step S22 to generate the relatively small control torque Tc by the second motor 17 within the range possible to satisfy both of the above-mentioned inequalities (1) and (2). Thereafter, the routine also progresses to step S4.

Instead, in the case that the answer of step S20 is NO, the noise and vibration reducing control may be terminated. In this case, the routine progresses directly from step S20 to step S5. Otherwise, the determination at step S20 may also be made prior to step S3. In this case, if the answer of step S20 is NO, an execution of the noise and vibration reducing control may be inhibited. In other words, in the case that the answer of step S20 is NO, the torque generation by the second motor 17 may be inhibited. Instead, in order to reduce the noises and shocks to a certain extent when launching or accelerating the vehicle Ve, it is also possible to generate torque smaller than the control torque Tc by the second motor 17. Thus, in the situation where it is not necessary to propel the vehicle Ve in the four-wheel drive mode, the torque of the second motor 17 may be reduced.

By thus increasing the control torque Tc when it is required to propel the vehicle Ve in the four-wheel drive mode, the acceleration response may be improved and the torques of the front wheels may be increased when accelerating the vehicle Ve. In addition, by thus reducing the control torque Tc or the output torque of the second motor 17 when it is not required to propel the vehicle Ve in the four-wheel drive mode, the fuel efficiency of the vehicle Ve may be improved.

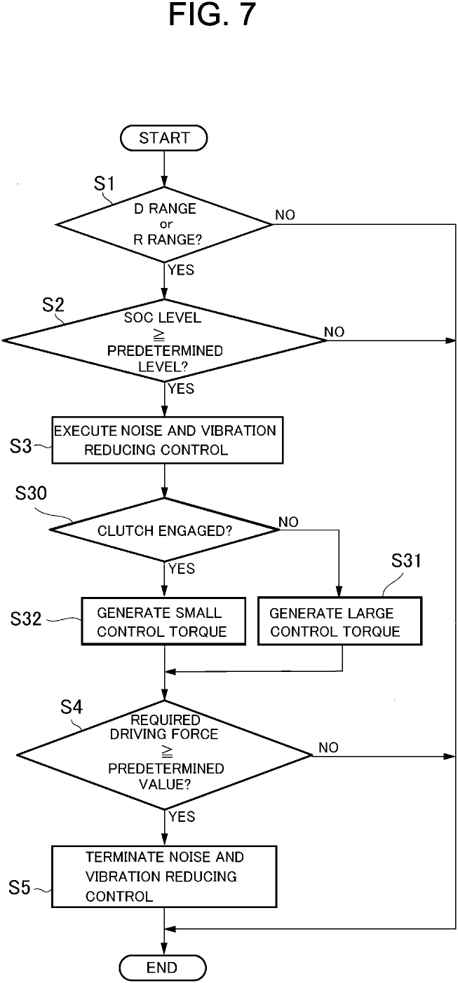

In the center differential unit 3, the sun gear 12, the carrier 15, and the ring gear 13 are rotated integrally by engaging the clutch 20. Consequently, the input torque Ti to the center differential unit 3 is distributed to the output shaft 11 and the carrier 15 in the same direction without generating the control torque Tc by the second motor 17. In addition, the torque may also be distributed to the output shaft 11 and the carrier 15 in the same direction by generating the control torque Tc by the second motor 17. Therefore, the control torque Tc may be reduced or an execution of the noise and vibration reducing control may be inhibited when the center differential unit 3 is locked by engaging the clutch 20. To this end, the control system according to the exemplary embodiment of the present disclosure is further configured to execute a routine shown in FIG. 7. In the following description, detailed explanations for the steps in common with those of the foregoing routines will be omitted.

In the routine shown in FIG. 7, the routine progresses from step S3 to step S30 to determine whether the clutch 20 is engaged. For example, such determination at step S30 may be made based on a transmission of a signal to an actuator (not shown) for actuating the clutch 20, or a stroke of a movable member of the clutch 20.

If the clutch 20 is disengaged so that the answer of step S30 is NO, it is necessary to generate the control torque Tc by the second motor 17 so as to eliminate the backlash existing in the gear pairs arranged between the center differential unit 3 and the front wheels. In this case, therefore, the routine progresses to step S31 to generate the relatively large control torque Tc by the second motor 17 within the range possible to satisfy both of the above-mentioned inequalities (1) and (2). Thereafter, the routine progresses to step S4. By contrast, if the clutch 20 is engaged so that the answer of step S30 is YES, the input torque Ti to the center differential unit 3 is distributed to the front wheels. That is, it is not necessary to generate the control torque Tc by the second motor 17, or it is sufficient to generate the relatively small torque by the second motor 17. In this case, therefore, the routine progresses to step S32 to generate the relatively small control torque Tc by the second motor 17 within the range possible to satisfy both of the above-mentioned inequalities (1) and (2). Thereafter, the routine also progresses to step S4.

Instead, in the case that the answer of step S30 is YES, the noise and vibration reducing control may be terminated. In this case, the routine progresses directly from step S30 to step S5. Otherwise, the determination at step S30 may also be made prior to step S3. In this case, if the answer of step S30 is YES, an execution of the noise and vibration reducing control may be inhibited. In other words, in the case that the answer of step S30 is YES, the torque generation by the second motor 17 may be inhibited. Instead, in order to reduce the noises and shocks to a certain extent when launching or accelerating the vehicle Ve, it is also possible to generate torque smaller than the control torque Tc by the second motor 17. Thus, in the situation where the clutch 20 is in engagement, the torque of the second motor 17 may be reduced.

By thus reducing the control torque Tc when the clutch 20 is in engagement, the fuel efficiency of the vehicle Ve may also be improved.

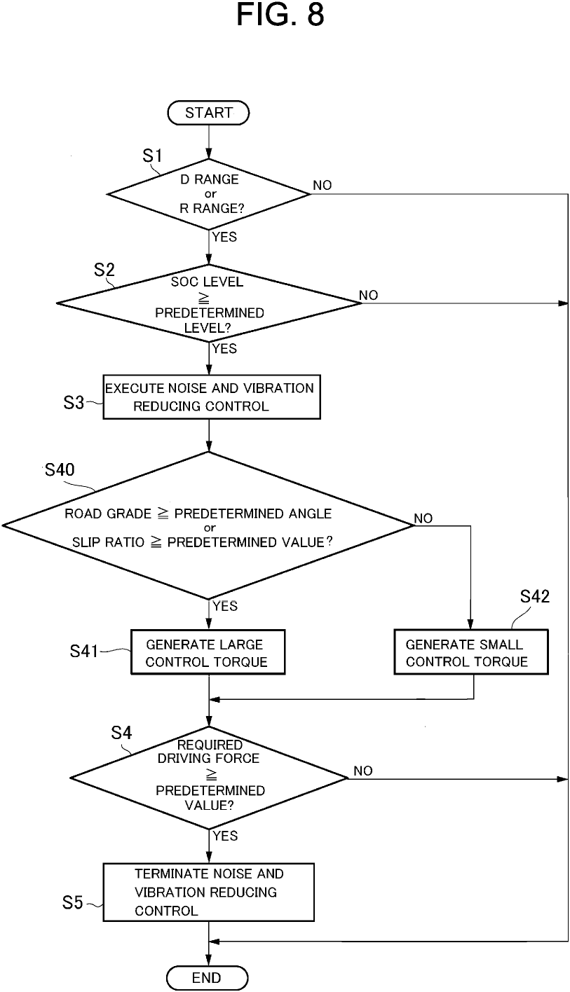

In addition, it is necessary to enhance controllability of the torque when launching or accelerating the vehicle Ve in the following situations e.g., where the vehicle Ve is stopped on an uphill slope, where the vehicle Ve is decelerated on an uphill slope by depressing a brake pedal, where the vehicle Ve is stopped on a slippery road, and where the vehicle Ve is decelerated on a slippery road. Therefore, it is preferable to eliminate the backlash existing in the gear pairs in the situations where the vehicle Ve is stopped or decelerated on an uphill slope or a slippery road. To this end, the control system according to the exemplary embodiment of the present disclosure is further configured to execute a routine shown in FIG. 8. In the following description, detailed explanations for the steps in common with those of the foregoing routines will be omitted.

In the routine shown in FIG. 8, the routine progresses from step S3 to step S40 to determine whether a road grade is a predetermined angle or greater, or whether a slip ratio of at least one of the pairs of the front wheels and the rear wheels is a predetermined value or greater. For example, the road grade may be measured based on a signal transmitted from an acceleration sensor, or graphics data collected by an on-board camera or a laser. Whereas, the slip ratio of the pair of wheels may be obtained based on a speed of the vehicle Ve just before the vehicle Ve is stopped and a speed of the pair of wheels.

If the road grade is the predetermined angle or greater so that the answer of step S40 is YES, or if the slip ratio of at least one of the pairs of the front wheels and the rear wheels is the predetermined value or greater so that the answer of step S40 is YES, it is preferable to generate the control torque Tc by the second motor 17 to eliminate the backlash existing in the gear pairs. In this case, therefore, the routine progresses to step S41 to generate the relatively large control torque Tc by the second motor 17 within the range possible to satisfy both of the above-mentioned expressions (1) and (2). Thereafter, the routine progresses to step S4. By contrast, if the road grade is smaller than the predetermined angle so that the answer of step S40 is NO, or if the slip ratio of at least one of the pairs of the front wheels and the rear wheels is less than the predetermined value so that the answer of step S40 is NO, the routine progresses to step S42 to generate the relatively small control torque Tc by the second motor 17 within the range possible to satisfy both of the above-mentioned inequalities (1) and (2). Thereafter, the routine also progresses to step S4.

Instead, in the case that the answer of step S40 is NO, the noise and vibration reducing control may be terminated. In this case, the routine progresses directly from step S40 to step S5. Otherwise, the determination at step S40 may also be made prior to step S3. In this case, if the answer of step S40 is NO, an execution of the noise and vibration reducing control may be inhibited. In other words, in the case that the answer of step S40 is NO, the torque generation by the second motor 17 may be inhibited. Instead, in order to reduce the noises and shocks to a certain extent when launching or accelerating the vehicle Ve, it is also possible to generate torque smaller than the control torque Tc by the second motor 17. Thus, in the situation where the road grade is smaller than the predetermined angle or the slip ratio of at least one of the pairs of the front wheels and the rear wheels is less than the predetermined value, the torque of the second motor 17 may be reduced.

By thus increasing the control torque Tc in the situation where the road grade is the predetermined angle or greater, or the slip ratio of at least one of the pairs of the front wheels and the rear wheels is the predetermined value or greater, the backlash existing in the gear pairs has already been eliminated when launching or accelerating the vehicle Ve. Therefore, an impact load will not be generated between the gears, and the controllability of the torques of the front wheels and the rear wheels may be improved. In addition, by thus reducing the control torque Tc or the output torque of the second motor 17 in the situation where the road grade is smaller than the predetermined angle or the slip ratio of at least one of the pairs of the front wheels and the rear wheels is less than the predetermined value, the fuel efficiency of the vehicle Ve may be improved.

What is claimed is:

1. A driving force control system for a vehicle, comprising:
a prime mover;
a first output shaft that delivers torque generated by the prime mover to any one of pairs of front and rear wheels;
a second output shaft that is connected to other one of the pairs of the front wheels and the rear wheels; and
a differential unit that connects the first output shaft, the second output shaft, and a motor in a differential manner, and that reverses a torque delivered from the motor to the second output shaft to a direction opposite to a direction of a torque delivered from the motor to the first output shaft,
the driving force control system comprising:
a controller that controls the prime mover and the motor,
wherein the controller is configured to generate a predetermined drive torque by the prime mover and a control torque falling within a predetermined range by the motor when stopping or decelerating the vehicle, such that a difference between the torque delivered from the prime mover to the first output shaft and the torque delivered from the motor to the first output shaft is increased to or greater than a first predetermined torque, and that the torque delivered from the motor to the second output shaft is increased to or greater than a second predetermined torque.

2. The driving force control system for the vehicle as claimed in claim 1, wherein the controller is further configured to adjust the control torque generated by the motor based on a predetermined condition including a running condition and an operating mode of the vehicle.

3. The driving force control system for the vehicle as claimed in claim 1, wherein the controller is further configured to generate the control torque by the motor based on a predetermined condition including a running condition and an operating mode of the vehicle.

4. The driving force control system for the vehicle as claimed in claim 2, wherein the predetermined condition includes whether the operating mode is in a fuel saving mode.

5. The driving force control system for the vehicle as claimed in claim 2, wherein the predetermined condition includes whether it is required to propel the vehicle in a mode in which the torque is distributed to both pairs of the front wheels and the rear wheels.

6. The driving force control system for the vehicle as claimed in claim 2,
wherein the vehicle further comprises a clutch that selectively connects at least any two of the first output shaft, the second output shaft, and the motor, and
the predetermined condition includes an engagement state of the clutch.

7. The driving force control system for the vehicle as claimed in claim 2, wherein the predetermined condition includes a road grade.

8. The driving force control system for the vehicle as claimed in claim 2, wherein the predetermined condition includes a slip ratio of at least one of the pairs of the front wheels and the rear wheels.

9. The driving force control system for the vehicle as claimed in claim 1,
wherein the vehicle further comprises an electric storage device that supplies an electric power to the motor, and
the controller is further configured to generate the control torque by the motor when a state of charge level of the electric storage device is a predetermined level or higher.
